(19) United States
(12) Patent Application Publication
(10) Pub. No.: US 2025/0157764 A1
(43) Pub. Date: May 15, 2025

(54) Thermal Protector

(71) Applicant: UCHIYA THERMOSTAT CO., LTD., Saitama (JP)

(72) Inventor: Hideaki Takeda, Saitama (JP)

(73) Assignee: UCHIYA THERMOSTAT CO., LTD., Saitama (JP)

(21) Appl. No.: 18/835,070

(22) PCT Filed: Feb. 10, 2023
(86) PCT No.: PCT/JP2023/004531

§ 371 Date: Aug. 1, 2024

(30) Foreign Application Priority Data
Feb. 18, 2022 (JP) 2022-023982

(51) Int. Cl. H01H 37/54

(52) U.S. Cl. CPC H01H 37/5418

(57) ABSTRACT

To enhance, in a cantilever bimetallic element, flexibility of setting a temperature of an inverting motion. A thermal protector includes a thermally actuated element having a substantially quadrangular non-fixed region, a fixed region that is connected to the non-fixed region along a longitudinal direction of the non-fixed region and is to be fixed to a stationary body, and a processed portion, a center of which is positioned inside a triangular region formed by a center of the non-fixed region and both ends of a boundary between the non-fixed region and the fixed region.

### TECHNICAL FIELD

The present invention relates to a thermal protector including a thermally actuated element.

### BACKGROUND ART

A bimetallic element is known that is a thermally actuated element used for a thermal protector.

Patent Document 1 describes a rectangular bimetallic element in a center portion of which a hole portion is provided. The hole portion is for positioning the bimetallic element.

Patent Document 2 describes a bimetallic element having an inverting region and a fixed region. A hole portion for fixation is provided in the fixed region.

Patent Document 3 describes a thermal protector in which a heat generating body is formed of a film-like resistor and the main heat generation region thereof is arranged near a bimetallic element.

### CITATION LIST

### Patent Literature

Patent Document 1: JP 2003-059378 A
Patent Document 2: JP H6-119859 A
Patent Document 3: JP H11-86703 A

### SUMMARY OF INVENTION

### Problem to be Solved by the Invention

There has been a problem in that, in a bimetallic cantilever element in which one end portion in the longitudinal direction is fixed, an inverting motion is restrained due to the one end portion being fixed, and setting of a temperature at which the bimetallic element makes the inverting motion (in particular, activation temperature) is restricted.

In view of the circumstances as above, an object of the present invention is to enhance, for a bimetallic cantilever element, flexibility of setting a temperature of an inverting motion.

### Means for Solving the Problems

A thermal protector according to an embodiment includes a thermally actuated element having: a substantially quadrangular non-fixed region; a fixed region that is connected to the non-fixed region along a longitudinal direction of the non-fixed region and is to be fixed to a stationary body; and a processed portion a center of which is positioned inside a triangular region formed by a center of the non-fixed region and both end portions of a boundary portion between the non-fixed region and the fixed region.

### Advantageous Effects of Invention

According to the present invention, in a bimetallic cantilever element, flexibility of setting a temperature of an inverting motion can be enhanced.

### BRIEF DESCRIPTION OF DRAWINGS

FIG. 1A is a plan view of a bimetallic element according to a first embodiment.

FIG. 1B is a planar sectional view of a thermal protector including the bimetallic element shown in FIG. 1A.

FIG. 1C is a plan view of a bimetallic element according to a modification of the first embodiment.

FIG. 2 is a plan view of a bimetallic element according to a second embodiment.

FIG. 3 is a plan view of a bimetallic element according to a third embodiment.

FIG. 4 is a plan view of a bimetallic element according to a fourth embodiment.

FIG. 5A is a plan view of a bimetallic element according to a fifth embodiment.

FIG. 5B is a sectional view taken along line A-A in FIG. 5A.

FIG. 6 is a perspective view of a bimetallic element according to a sixth embodiment.

### MODE FOR CARRYING OUT THE INVENTION

Hereafter, the present invention will be described based on illustrative embodiments. Note that the present invention is not limited to the embodiments described below.

### First Embodiment

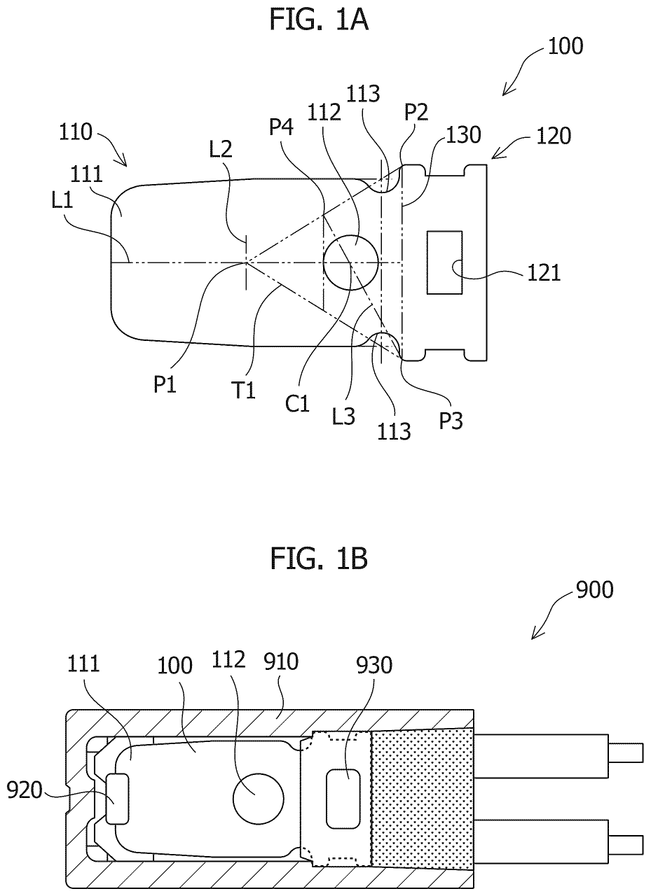

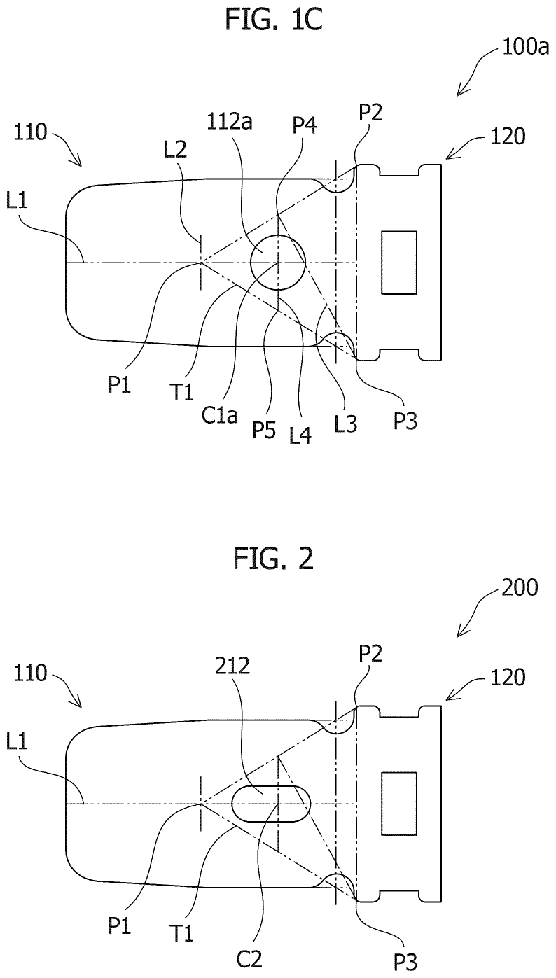

FIG. 1A shows a bimetallic element 100 which is a plate-like thermally actuated element having a substantially rectangular shape overall. FIG. 1B is a planar sectional view of a thermal protector 900 including the bimetallic element 100. The bimetallic element 100 has a non-fixed region 110 and a fixed region 120 that are adjacent in the longitudinal direction. The boundary between the non-fixed region 110 and the fixed region 120 is denoted by reference sign 130.

The non-fixed region 110 is curved such that at least part thereof is convex upward when the bimetallic element 100 is horizontally placed at ambient temperature, and its curving direction is inverted such that the part becomes convex downward, when the temperature of the region becomes a predetermined activation temperature. After the inverting, when the temperature of the non-fixed region 110 becomes a predetermined recovery temperature, the inverted part is re-inverted so as to be convex upward. A tip portion 111 of the non-fixed region 110 is engaged with a claw portion 910 that is formed at an end portion of a movable conductive plate positioned beneath the bimetallic element 100 in a housing 910 of the thermal protector 900.

The fixed region 120 is wider in width than the non-fixed region 110. A hole portion 121 is formed at a substantial center of the fixed region 120. This hole portion 121 is engaged and fixed to a columnar portion 930 that is formed so as to extend in the up-down direction in the housing 910.

As above, the cantilever bimetallic element 100 in which the fixed region 120 is fixed and the non-fixed region 110 is not fixed. That is, the entire non-fixed region 110, except the fixed region 120, of the bimetallic element 100 is an inverting region that is inverted when it reaches the activation temperature.

A center of the non-fixed region 110 is denoted by sign P1. The center P1 is the intersection of a center line L1 extending in the longitudinal direction of the non-fixed region 110 and a center line L2 extending in the width direction of the region. A triangular region T1 is formed by the center P1 and both end points P2 and P3 of the boundary 130. A circular processed portion (hole portion by punch processing) 112 is provided in the non-fixed region 110, and a center C1 of this circular processed portion 112 is positioned in the triangular region T1. In detail, the center C1 coincides with the intersection of a line L3 connecting a middle point P4 of the side connecting the center P1 and the end point P2 and the end point P3 and the center line L1.

A bimetallic cantilever element that includes a fixed region and a non-fixed region, since the fixed region is fixed, an inverting motion of the non-fixed region tends to be restrained. This tendency is more significant as fixing strength of the fixed region is higher. The inventor has found that the triangular region denoted by reference sign T1 relates to the restraint of the inverting motion.

Therefore, the circular processed portion mentioned above is provided in the bimetallic element. Thereby, the restraining action of the inverting motion occurring in the triangular region mentioned above can be reduced. As a result, a region within which the activation temperature is set can be enlarged.

According to the present embodiment, by partially providing a processed portion such as a hole in an inverting bimetallic element, large stress can be made not to occur on a side near the fixed region, and the occurring stress can be readily relieved. As a result, an even wider range of temperature can be set. An outer shape and a material used can be maintained as in conventional ones.

Moreover, a stroke in inverting (distance of motion) of the tip portion of the non-fixed region can be enlarged in a temperature region near 100° C. Moreover, a narrow hysteresis can be set in this temperature region and a lower temperature region than this temperature region. Drawing processing deeper than conventional one can be performed in a higher temperature region than that temperature region.

As a result, a wider activation temperature region than a conventional one can be set, and a narrower hysteresis, or conversely, a wider hysteresis than a conventional one can be set.

For a temperature switch such as a thermal protector, a wide temperature region can be set.

The processed portion by punching is not limited to being circular, and it may have an elliptical or oval shape that is long in the width direction, and may have a polygonal shape (not shown) in which the vertices are rounded. Furthermore, it may have a shape based on a U-shape or a V-shape.

On the other hand, the punching causes a decrease in inverting force since it is processing that reduces area. This can be handled by increasing the thickness of the material.

Moreover, the inverting force can also be reinforced by changing the outer shape within allowances. Accordingly, the ratio between the length and the width of the outer shape can be changed. Furthermore, there can also be employed a barrel shape, the center portion of which in the longitudinal direction is enlarged outward in the width direction, or a polygonal shape in which the width gradually decreases toward the tip portion.

In addition, when the area of the processed portion provided in connection with the triangular region mentioned above is too wide, this causes the inverting force to decrease, which disables the snap-action. Accordingly, the area of the processed portion is desirably not more than 15% of the area of the non-fixed region 110 before the punching processing.

In regions, on the boundary 130 side, of both end portions in the width direction of the non-fixed region 110, constriction portions, the dimension of which in the width direction decreases, and that are adjacent to the boundary, are provided.

Moreover, as shown in FIG. 1C, a circular processed portion (hole portion) 112a may be provided in a bimetallic element 100a. A center C1a of the circular processed portion 112a coincides with the intersection of a line L4 connecting a middle point P5 of the side connecting the center P1 and the end point P3 and the middle point P4 and the center line L1. Alternatively, the relevant circular processed portion may be provided such that the center of the circular processed portion is on the center line L1 and is positioned between the point C1 (FIG. 1A) and the point C1a (FIG. 1C).

### Second Embodiment

FIG. 2 shows a bimetallic element 200 according to the present embodiment. The same elements as those in FIG. 1A are given the same reference signs, and detailed description thereof is omitted. In the bimetallic element 200, there is provided a processed portion (hole part) 212 having an oval shape that is long in the same direction as the longitudinal direction of the bimetallic element. A center of this processed portion 212 is positioned on the center line L1. The entire processed portion 212 may be inside the triangular region T1, or a part of the processed portion 212 may be positioned in the fixed region 120.

Although the activation temperature is set by a procedure similar to that in the first embodiment, in order to reduce stress generated by processing in the triangular region, by providing the oval-shaped cutout portion as above, stress in performing drawing processing decreases, and the processing into a deeper shape has been made possible. This indicates that a wider temperature setting is made possible and that the recovery temperature can be widely set since the longitudinal cutout leads to a greater hysteresis.

### Third Embodiment

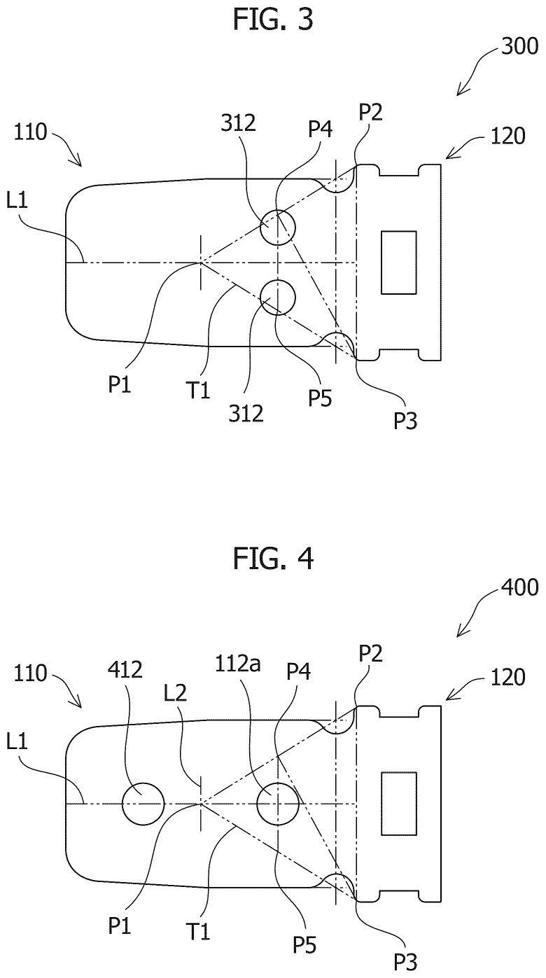

In a bimetallic element 300 shown in FIG. 3, two processed portions (hole portions) 312 are provided so as to line up in the width direction. Both processed portions are circular, and their centers are on a line segment connecting the point P4 and the point P5. Moreover, each of both processed portions is positioned so as to overlap with any one of the side thereof connecting the point P1 and the point P2 and the side thereof connecting the point P1 and the point P3 of the triangular region T1.

As compared with the case of one circular portion, by arranging two small circular portions, an influence due to additional processing can be readily adjusted, and a change of the hysteresis can be restrained.

### Fourth Embodiment

A bimetallic element 400 shown in FIG. 4 further includes, in addition to the configuration of the bimetallic element 100a shown in FIG. 1C, a circular processed portion (hole portion) 412 that is at a symmetric position with the processed portion 112a with respect to the center line L2.

By providing the processed portion 112a, the center of which is positioned in the triangular region and the processed portion 412 that is outside the triangular region, stress relief with respect to the inverting motion advances, a warping shape after the inverting motion is larger, a movable range of the non-fixed region due to the inverting motion is enlarged, a contact motion is large, and a contact gap (gap between a movable contact and a fixed contact in the thermal protector) can be set to be large.

Since the area of the non-fixed region decreases as compared with that before punching processing, this causes the inverting force to decrease. As a method of improving this, the thickness of the bimetallic element can be increased to increase the inverting force.

### Fifth Embodiment

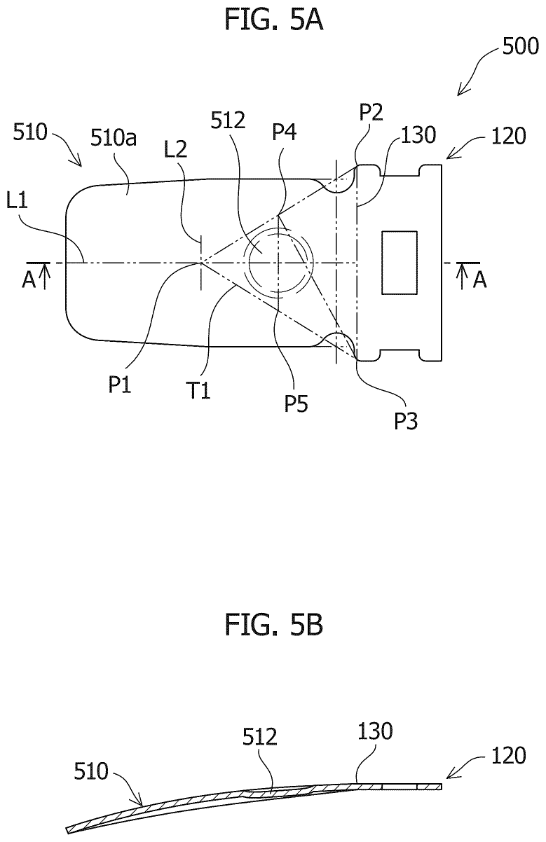

In a bimetallic element 500 shown in FIG. 5A and FIG. 5B, a circular processed portion 512 is provided in the triangular region T1. This processed portion 512 is formed, not by punch processing, but by drawing processing so as not to be inverted even when the temperature of the bimetallic element reaches the activation temperature. Specifically, while an inverting region 510a, except for the processed portion 512, of a non-fixed region 510 of the bimetallic element 500, is curved to be convex upward, the processed portion (drawing processed portion) 512 is curved to be convex downward.

As above, by performing drawing processing such that curving directions are directly opposite on the inverting region 510a and the processed portion 512, an action of restraining the inverting motion is small, and similar effects to that in the case of punch processing are attained.

Notably, in the case which the curving directions are made the same merely with different curvatures on the inverting region 510a and the processed portion 512, the action of restraining the inverting motion is greater than in the case in which the relevant processed portion does not exist.

This is because, although the drawing processing to make the processed portion convex downward attains the effect of promoting the inverting of the inverting region except 512, drawing processing to make the processed portion convex upward acts to restrain the inverting of the inverting region except 512.

The more definite a contour portion of the processed portion 512 is, the greater the effect of promoting the inverting is. When the contour portion is obscure, that is, when the inverting region 510a and the processed portion 512 are connected with a curved surface, skirts of the drawing shape are large, and the effect of promoting the inverting is small. Notably, the depth of the drawing is not very important, and shallow processing is preferable as long as the shape can be maintained.

### Sixth Embodiment

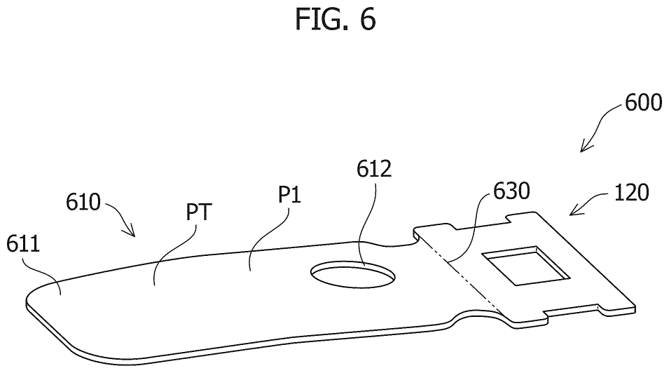

As shown in FIG. 6, a bimetallic element 600 according to the present embodiment has a non-fixed region 610 and a fixed region 120. The non-fixed region 610 is curved so as to be convex upward as viewed along the width direction and the longitudinal direction of the bimetallic element 600 such that a predetermined inverting temperature is set as to the non-fixed region 610. This curving is attained by drawing processing. A vertex PT of this curved shape is positioned between the center P1 and a tip portion 611 of the non-fixed region 610. In other words, the vertex PT is eccentric to the tip portion 611 side that has a large inverting motion. The curvature of the curved shape from the vertex PT to the tip portion 611 is greater than the curvature of the curved shape from the vertex PT to a boundary 630 between the non-fixed region 610 and the fixed region 120. That is, the triangular region formed by both end portions of the boundary 630 and the center P1 has a relatively gently sloping curved shape. A processed portion (hole portion) 612 is provided in this triangular region.

The embodiments above relate to processing of a bimetallic element used for a thermal protector that opens and closes current by driving a movable plate (or conductive plate) and a movable contact. For a cantilever bimetallic element, there is attained an effect of enhancing flexibility of setting a temperature of an inverting motion by providing a processed portion (hole portion or drawing processed portion) at a portion at which high stress causing an action of restraining the inverting motion occurs. In particular, there can be provided a cantilever bimetallic element, the activation temperature of which is set to a relatively high value, that has been conventionally difficult to provide. As an example, while the upper limit of the activation temperature is conventionally about 150° C., according to the embodiments above, the upper limit of the activation temperature can be increased up to about 200° C.

Out of the embodiments mentioned above, two or more embodiments can be combined as long as no conflict arises.

The embodiments mentioned above can also be applied to thermally actuated elements other than bimetallic elements, such as a shape memory alloys (100° C. or below) and trimetals.

Regarding the embodiments described above, the following additional supplements are disclosed.

### Supplement 1

A thermal protector including a thermally actuated element having:
a substantially quadrangular non-fixed region;
a fixed region that is connected to the non-fixed region along a longitudinal direction of the non-fixed region and is to be fixed to a stationary body; and
a processed portion a center of which is positioned inside a triangular region formed by a center of the non-fixed region and both end portions of a boundary portion between the non-fixed region and the fixed region.

### Supplement 2

The thermal protector according to Supplement 1, wherein
the thermally actuated element includes a constriction portion that is adjacent to the boundary at both end portions of the non-fixed region in a width direction and a dimension of which in the width direction decreases, and
the processed portion is a hole portion.

### Supplement 3

The thermal protector according to Supplement 1, wherein the processed portion has an oval shape that is long in the longitudinal direction of the non-fixed region.

### Supplement 4

The thermal protector according to Supplement 1, wherein
a number of the processed portion is two,
one of the processed portions is positioned so as to overlap with one of two sides of the triangular region that extend from the center of the non-fixed region, and
the other of the processed portions is positioned so as to overlap with the other of the two sides.

### Supplement 5

The thermal protector according to Supplement 1, wherein the thermally actuated element has a further processed portion at a symmetric position with the processed portion with respect to a line that goes through the center of the non-fixed region and extends in a width direction.

### Supplement 6

The thermal protector according to Supplement 1, wherein a portion except the processed portion out of the non-fixed region, and the processed portion are curved, and have curving directions different from each other.

### Supplement 7

The thermal protector according to Supplement 1, wherein the non-fixed region has a curved shape, and a vertex of the non-fixed region is positioned between the center of the non-fixed region and a tip portion of the non-fixed region in the longitudinal direction.

Embodiments of the present invention have been described above, but the present invention is not limited to the embodiments described above, and various modifications and alterations may be made based on the technical concept of the present invention.

### REFERENCE SIGNS LIST

100, 100a, 200, 300, 400, 500, 600 bimetallic element
110 non-fixed region
111 tip portion
112, 112a, 212, 312, 412, 512, 612 processed portion
120 fixed region
130 boundary
T1 triangular region

1. A thermal protector comprising a thermally actuated element having:
a substantially quadrangular non-fixed region;
a fixed region that is connected to the non-fixed region along a longitudinal direction of the non-fixed region and is fixed to a stationary body; and
a processed portion a center of which is positioned inside a triangular region formed by a center of the non-fixed region and both end portions of a boundary portion between the non-fixed region and the fixed region.

2. The thermal protector according to claim 1, wherein
the thermally actuated element includes a constriction portion that is adjacent to the boundary at both end portions of the non-fixed region in a width direction, and a dimension of the constriction portion in the width direction decreases, and
the processed portion is a hole portion.

3. The thermal protector according to claim 1, wherein
the processed portion has an oval shape that is long in the longitudinal direction of the non-fixed region.

4. The thermal protector according to claim 1, wherein
a number of the processed portion is two,
one of the processed portions is positioned so as to overlap with one of two sides of the triangular region that extend from the center of the non-fixed region, and
the other of the processed portions is positioned so as to overlap with the other of the two sides.

5. The thermal protector according to claim 1, wherein the thermally actuated element has a further processed portion at a symmetric position with the processed portion with respect to a line that passes through the center of the non-fixed region and extends in a width direction.

6. The thermal protector according to claim 1, wherein a portion except for the processed portion out of the non-fixed region, and the processed portion, are curved, and have curving directions different from each other.

7. The thermal protector according to claim 1, wherein the non-fixed region has a curved shape, and a vertex of the non-fixed region is positioned between the center of the non-fixed region and a tip portion of the non-fixed region in the longitudinal direction.
